(19) United States
(12) Patent Application Publication
(10) Pub. No.: US 2024/0274149 A1
(43) Pub. Date: Aug. 15, 2024

(54) SIGNAL PROCESSING DEVICE, SIGNAL PROCESSING METHOD, AND SIGNAL PROCESSING PROGRAM

(71) Applicant: NIPPON TELEGRAPH AND TELEPHONE CORPORATION, Tokyo (JP)

(72) Inventors: Hiroshi SATO, Musashino-shi, Tokyo (JP); Tsubasa OCHIAI, Musashino-shi, Tokyo (JP); Marc DELCROIX, Musashino-shi, Tokyo (JP); Keisuke KINOSHITA, Musashino-shi, Tokyo (JP)

(73) Assignee: NIPPON TELEGRAPH AND TELEPHONE CORPORATION, Tokyo (JP)

(21) Appl. No.: 18/561,727

(22) PCT Filed: May 25, 2021
(86) PCT No.: PCT/JP2021/019874

§ 371 Date: Nov. 16, 2023

(51) Int. Cl. G10L 21/0308; G10L 21/0208; G10L 25/84

(52) U.S. Cl. CPC G10L 21/0308; G10L 21/0208; G10L 25/84

(57) ABSTRACT

A voice recognition input determination unit includes SIR-SNR acquisition circuitry that acquires, from a mixed voice in which a voice of another speaker overlaps with a voice of a target speaker, at least one of the mixed voice and a set of a signal-to-interference ratio (SIR) that is a ratio of a target voice to an interference speaker voice in the mixed voice and a signal-to-noise ratio (SNR) that is a ratio of the target voice to a noise in the mixed voice. Further, there is determination circuitry that determines a voice based on at least one of the mixed voice and an enhanced voice obtained by enhancing the mixed voice as a voice to be used for voice recognition on the basis of at least one of the mixed voice and the set of the SIR and the SNR.

### TECHNICAL FIELD

The present invention relates to a signal processing device, a signal processing method, and a signal processing program.

### BACKGROUND ART

With the development of deep learning technology, voice recognition accuracy is improved, and an application range of voice recognition is gradually expanded. However, even at present, in a case where a plurality of voices is uttered redundantly, it is difficult to recognize the plurality of voices.

Therefore, various techniques for coping with overlapping of voices have been devised. A blind sound source separation technique is one of the approaches, and is a technique for separating a mixed sound into sounds derived from sound sources included therein. The blind sound source separation technique can enable voice recognition by separating a voice as a mixed sound that is difficult to recognize into speakers' respective voices (see, for example, Non Patent Literature 1).

In addition, a target speaker extraction technique has been proposed. The target speaker extraction technique is a technique in which a speech preregistered by a target speaker is used as auxiliary information, and only a voice of the preregistered speaker is acquired from a mixed sound. This target speaker extraction technique has an advantage of not requiring prior information regarding the number of speakers included in the mixed sound, and is a practically useful technique (see, for example, Non Patent Literature 2). The voice extracted by use of the target speaker extraction technique includes only the voice of the target speaker, and thus voice recognition is possible.

### CITATION LIST

### Non Patent Literature

Non Patent Literature 1: Dong Yu, et al, “PERMUTATION INVARIANT TRAINING OF DEEP MODELS FOR SPEAKER-INDEPENDENT MULTI-TALKER SPEECH SEPARATION”, 2017 IEEE International Conference on Acoustics, Speech and Signal Processing (ICASSP), IEEE, 2017.
Non Patent Literature 2: Zmolikova Katerina, et al, “SpeakerBeam: Speaker Aware Neural Network for Target Speaker Extraction in Speech Mixtures”, IEEE Journal of Selected Topics in Signal Processing 13.4 (2019): 800-814. Non Patent Literature 3: Quan Wang, et al, “VoiceFilter-Lite: Streaming Targeted Voice Separation for On-Device Speech Recognition”, arXiv preprint arXiv: 2009.04323 (2020).

### SUMMARY OF INVENTION

### Technical Problem

As described above, the voice enhancement technique is a technique that makes it possible to remove undesirable sounds in a case where the voice of the target speaker overlaps with a voice of another speaker or overlaps with a background noise, and to extract only the voice of the target speaker. However, when the undesirable sounds are removed, the desired voice of the target speaker may be distorted at the same time.

In a case where voice recognition is performed on the voice to which the voice enhancement technique is applied, the distortion of the voice of the target speaker may cause deterioration in voice recognition performance. Such deterioration in voice recognition performance is a major problem in actual operation of extracting a target speaker from a real voice in which a voice of another speaker does not necessarily overlap with a voice of the target speaker.

Meanwhile, since voice recognition operates with small performance deterioration even if there is a certain amount of noise, not extracting a target speaker may make voice recognition performance better depending on the degree and type of noise. That is, it is desirable to compare an effect of noise removal by application of the voice enhancement technique with an adverse effect of distortion associated therewith, to perform the noise removal in a case where the former is larger, and not to perform voice enhancement in a case where the latter is larger.

For example, Non Patent Literature 3 proposes a method introducing a binary discriminator that discriminates whether the type of noise is a voice of another speaker or another noise, on the basis of the knowledge that voice enhancement is effective in a case where the noise is a voice of another speaker (voice noise) while voice enhancement is likely to deteriorate voice recognition in a case where the noise is not a voice (non-voice noise). In the method, voice enhancement is performed only in a case where the type of noise is a voice of another speaker. That is, Non Patent Literature 3 proposes not performing voice enhancement in a case where there is no voice of another speaker in a voice of a target speaker, and performing voice enhancement only in a case where the voices overlap.

However, even in a case where voices of a plurality of speakers are redundantly uttered, voice enhancement may be deteriorated if performance deterioration caused by the presence of an interference speaker voice is exceeded by performance deterioration due to distortion caused by removal of the interference speaker voice.

The present invention has been made in view of the above, and an object of the present invention is to provide a signal processing device, a signal processing method, and a signal processing program capable of appropriately determining at least one of a mixed voice and an enhanced voice obtained by enhancing the mixed voice as an input voice capable of improving the accuracy of voice recognition in a case where a voice of another speaker overlaps with a voice of a target speaker.

### Solution to Problem

In order to solve the above-described problems and achieve the object, a signal processing device according to the present invention includes: an acquisition unit that acquires, from a mixed voice in which a voice of another speaker overlaps with a voice of a target speaker, at least one of the mixed voice and a set of a signal-to-interference ratio (SIR) that is a ratio of a target voice to an interference speaker voice in the mixed voice and a signal-to-noise ratio (SNR) that is a ratio of the target voice to a noise in the mixed voice; and a determination unit that determines a voice based on at least one of the mixed voice and an enhanced voice obtained by enhancing the mixed voice as a voice to be used for voice recognition on the basis of at least one of the mixed voice and the set of the SIR and the SNR.

### Advantageous Effects of Invention

According to the present invention, in a case where a voice of another speaker overlaps with a voice of a target speaker, at least one of a mixed voice and an enhanced voice obtained by enhancing the mixed voice can be appropriately determined as an input voice capable of improving the accuracy of voice recognition.

### BRIEF DESCRIPTION OF DRAWINGS

FIG. 1 is a diagram schematically illustrating an example of a configuration of a signal processing device according to an embodiment.

FIG. 2 is a diagram schematically illustrating an example of a configuration of a voice recognition input determination unit illustrated in FIG. 1.

FIG. 3 is a diagram illustrating voice recognition performance for an enhanced voice obtained by enhancing a mixed voice.

FIG. 4 is a diagram illustrating voice recognition performance for the mixed voice.

FIG. 5 is a flowchart illustrating a processing procedure of signal processing according to the embodiment.

FIG. 6 is a flowchart illustrating a processing procedure of voice recognition input determination processing illustrated in FIG. 5.

FIG. 7 is a diagram illustrating voice recognition results in a case where the signal processing device according to the embodiment is applied.

FIG. 8 is a diagram illustrating a performance improvement rate of the voice recognition results using the signal processing device according to the embodiment with respect to voice recognition results in a case where the enhanced voice is used.

FIG. 9 is a diagram illustrating an example of a computer in which a program is executed and thus the signal processing device is implemented.

### DESCRIPTION OF EMBODIMENTS

Hereinafter, an embodiment of the present invention will be described in detail with reference to the drawings. Note that the present invention is not limited by this embodiment. In the drawings, the same portions are denoted by the same reference signs.

### Embodiment

Even in a case where a voice of another speaker overlaps with a voice of a target speaker, it may be better not to perform voice enhancement. For example, in a case where the voice of the interference speaker has a smaller amplitude than the voice of the target speaker, there is a case where it is possible to recognize the voice of the target speaker to some extent in voice recognition without performing voice enhancement. In addition, it is confirmed that, in a case where there is non-voice noise other than the voice of the interference speaker, the influence of distortion due to voice enhancement tends to be large. In such a case, an adverse effect of voice enhancement is large, and it may be advantageous for voice recognition to recognize the original mixed voice.

Therefore, a signal processing device according to the embodiment targets a mixed voice in which a voice of another speaker overlaps with a voice of a target speaker, and determines a voice based on at least one of the mixed voice and an enhanced voice obtained by enhancing the mixed voice as an input voice capable of improving the accuracy of voice recognition. The signal processing device according to the embodiment determines the voice based on at least one of the mixed voice and the enhanced voice on the basis of at least one of the mixed voice and a set of a signal-to-noise ratio (SNR) that is a ratio of a target voice to a noise in the mixed voice and a signal-to-interference ratio (SIR) that is a ratio of the target voice to an interference speaker voice in the mixed voice. The signal processing device according to the embodiment performs voice recognition processing using the determined voice based on at least one of the mixed voice and the enhanced voice, and thus can improve the voice recognition accuracy.

### [Signal Processing Device]

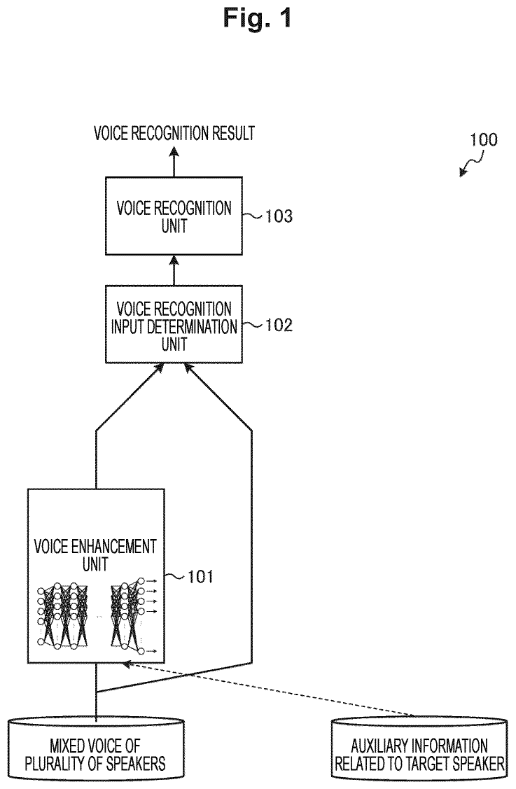

Next, the signal processing device according to the embodiment will be described. FIG. 1 is a diagram schematically illustrating an example of a configuration of the signal processing device according to the embodiment.

A signal processing device 100 is implemented by, for example, a predetermined program being read by a computer or the like including a read only memory (ROM), a random access memory (RAM), a central processing unit (CPU), and the like, and the CPU executing the predetermined program. Furthermore, the signal processing device 100 includes a communication interface that transmits and receives various types of information to and from another device connected in a wired manner or connected via a network or the like. The signal processing device 100 includes a voice enhancement unit 101, a voice recognition input determination unit 102, and a voice recognition unit 103.

The voice enhancement unit 101 extracts a desired voice from an input mixed voice using a known voice enhancement technique. As processing of the voice enhancement unit 101, a known sound source separation technique or a known target speaker extraction technique can be applied. In the sound source separation technique, since an input mixed voice is separated into speakers' respective voices, the speakers' respective voices are independently given to the voice recognition input determination unit 102. In the target speaker extraction technique, it is necessary to give auxiliary information related to a target speaker as an input. As the auxiliary information related to the target speaker, for example, a speech registered in advance by the target speaker is used. Note that the auxiliary information related to the target speaker may be held by the signal processing device 100 or may be input from an external device capable of communicating with the signal processing device 100.

The voice enhancement unit 101 extracts an enhanced voice obtained by enhancing the mixed voice. For example, in a case where a mixed voice including voices of the target speaker and another interference speaker is input as a mixed voice to the voice enhancement unit 101, the voice enhancement unit 101 extracts the voice of the target speaker who has uttered the preregistered speech from the mixed voice. The voice enhancement unit 101 inputs the extracted voice as the enhanced voice to an SIR-SNR acquisition unit 1021 (described later) of the voice recognition input determination unit 102. Each of the mixed voice and the enhanced voice to be input may be a voice obtained by performing some conversion such as feature extraction on a voice, or may be a voice waveform.

On the basis of at least one of the mixed voice and a set of an SNR of the mixed voice and an SIR of the mixed voice, the voice recognition input determination unit 102 determines a voice based on at least one of the mixed voice and the enhanced voice obtained by enhancing the mixed voice as a voice to be used for voice recognition. The voice recognition input determination unit 102 inputs the determined voice based on at least one of the mixed voice and the enhanced voice to the voice recognition unit 103. The voice recognition input determination unit 102 determines, as a speech to be input to the voice recognition, the voice based on at least one of the enhanced voice as an output of the voice enhancement unit 101 and the mixed voice input to the signal processing device 100, in a fixed section unit such as a speech unit or a frame.

Specifically, the voice recognition input determination unit 102 performs voice determination hard. For example, with “1” and “0”, the voice recognition input determination unit 102 inputs, to the voice recognition unit 103, only one of the enhanced voice as an output of the voice enhancement unit 101 and the mixed voice input to the signal processing device 100.

Furthermore, the voice recognition input determination unit 102 can also perform voice determination softly. For example, the voice recognition input determination unit 102 performs, for example, weighting of “0.3” on one of the enhanced voice as an output of the voice enhancement unit 101 and the mixed voice input to the signal processing device 100, performs weighting of “0.7” on the other, and inputs the weighted mixed voice and enhanced voice to the voice recognition unit 103.

The voice recognition unit 103 performs voice recognition processing using the voice based on at least one of the mixed voice and the enhanced voice determined by the voice recognition input determination unit 102. A known voice recognition technique can be applied to the voice recognition processing of the voice recognition unit 103.

### [SIR, SNR]

Here, an arithmetic expression of the SIR is shown in Expression (1), and an arithmetic expression of the SNR is shown in Expression (2). In Expressions (1) and (2), S is the voice of the target speaker, I is the voice of the interference speaker, and N is a noise.

$$\begin{matrix}[ Math . 1 ] & \\ SIR = 10 {log}_{10} \frac{{‖ S ‖}^{2}}{{‖ I ‖}^{2}} & ( 1 )\end{matrix}$$

$$\begin{matrix}[ Math . 2 ] & \\ SNR = 10 {log}_{10} \frac{{‖ S ‖}^{2}}{{‖ N ‖}^{2}} & ( 2 )\end{matrix}$$

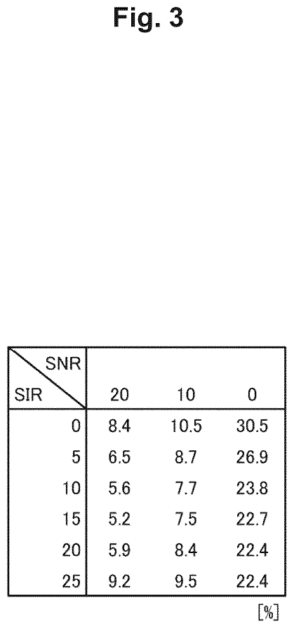

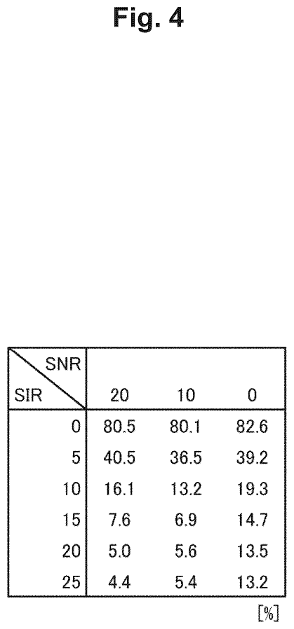

FIG. 3 is a diagram illustrating voice recognition performance for the enhanced voice obtained by enhancing the mixed voice. FIG. 4 is a diagram illustrating voice recognition performance for the mixed voice. In both FIGS. 3 and 4, a character error rate was evaluated as voice recognition performance.

As illustrated in FIGS. 3 and 4, it has been experimentally found that, in voice recognition, which of the enhanced voice obtained by enhancing the mixed voice and the original mixed voice is advantageous as an input depends on the SIR and the SNR. Specifically, as a value obtained by subtracting the SNR from the SIR is larger, the character error rate is lower in a case where the mixed voice is input instead of the enhanced voice.

Therefore, by estimating the SIR and the SNR from the input voice, the voice recognition input determination unit 102 selects the enhanced voice for a region of the SNR and the SIR where the accuracy of voice recognition can be improved in FIG. 3, selects the mixed voice for the other regions, and inputs the selected voice to the voice recognition unit 103. Alternatively, the voice recognition input determination unit 102 weights the enhanced voice larger than the mixed voice for the region of the SNR and the SIR where the accuracy of voice recognition can be improved in FIG. 3, weights the mixed voice larger than the enhanced voice for the other regions, and inputs the weighted mixed voice and enhanced voice to the voice recognition unit 103.

### [Voice Recognition Input Determination Unit]

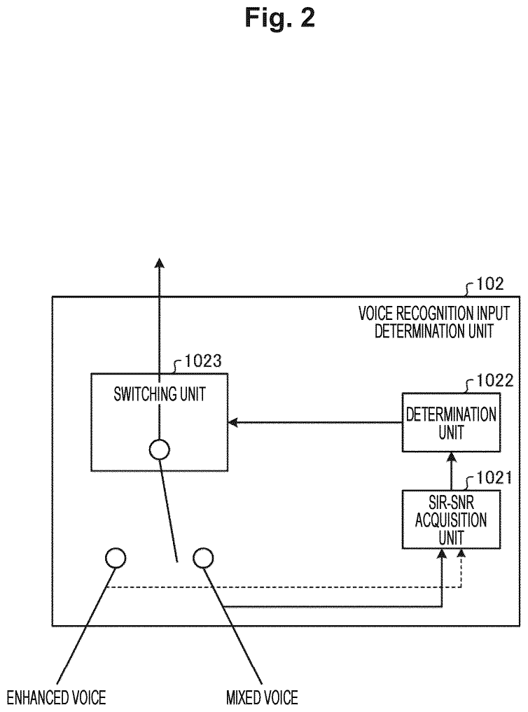

Next, the voice recognition input determination unit 102 will be described. FIG. 2 is a diagram schematically illustrating an example of a configuration of the voice recognition input determination unit 102 illustrated in FIG. 1.

As illustrated in FIG. 2, the voice recognition input determination unit 102 includes the SIR-SNR acquisition unit 1021 (acquisition unit), a determination unit 1022, and a switching unit 1023.

The SIR-SNR acquisition unit 1021 acquires, from a mixed voice input to the system, at least one of the mixed voice and a set of an SIR of the mixed voice and a SNR of the mixed voice. The SIR-SNR acquisition unit 1021 may acquire the SIR and the SIR in a fixed time unit such as a frame, or may acquire the SIR and the SIR in a speech unit.

The SIR-SNR acquisition unit 1021 estimates the SIR and the SNR using, for example, an estimation model for estimating the SIR and the SNR. The estimation model is configured by a neural network or the like. The estimation model is obtained by learning pair data of a voice and a set of an SIR and an SNR in advance.

In a case where a voice of a target speaker and a voice of another interference speaker are extracted by the voice enhancement unit 101, the SIR-SNR acquisition unit 1021 may calculate the SIR and the SIR using Expressions (1) and (2) on the basis of the extracted voice of the target speaker and the extracted voice of the another interference speaker.

On the basis of at least one of the mixed voice and the set of the SIR and the SNR acquired by the SIR-SNR acquisition unit 1021, the determination unit 1022 determines a voice based on at least one of the mixed voice and an enhanced voice obtained by enhancing the mixed voice as a voice to be used for voice recognition. On the basis of at least one of the mixed voice and the set of the SIR and the SNR estimated or calculated by the SIR-SNR acquisition unit 1021, the determination unit 1022 determines which of the mixed voice and the enhanced voice obtained by enhancing the mixed voice is more advantageous for voice recognition.

For example, the determination unit 1022 uses a predetermined rule using the SIR and the SNR to determine the voice based on at least one of the mixed voice and the enhanced voice as a voice to be used for voice recognition. In a case where the voice determination is performed hard, the determination unit 1022 uses a rule of selecting the enhanced voice in a case of Expression (3), for example.

$$\begin{matrix}[ Math . 3 ] & \\ SIR - SNR ≦ 10 & ( 3 )\end{matrix}$$

Furthermore, the determination unit 1022 may perform the determination using a rule in which a weight value for the mixed voice and a weight value for the enhanced voice are set in advance according to a combination of the SIR and the SNR, on the basis of the fact that which of the mixed voice and the enhanced voice is advantageous as an input for voice recognition depends on the SIR and the SNR (see FIGS. 3 and 4).

In a case where the voice determination is performed softly, the determination unit 1022 may determine the voice based on at least one of the mixed voice and the enhanced voice as a voice to be used for voice recognition using an identification model for identifying the voice based on at least one of the mixed voice and the enhanced voice as an input to the voice recognition unit 103.

The identification model is configured by a neural network or the like. The identification model is obtained by learning in advance at least one of feature amounts acquired from mixed voices and sets of an SNR and an SIR as inputs. Each of the feature amounts and the sets of an SNR and an SIR is provided with a teacher label indicating which of a mixed voice and an enhanced voice is advantageous as a voice to be used for voice recognition.

In a case where the identification model uses a set of an SNR and an SIR as an input, the identification model is learned on the basis of pair data of a teacher label indicating which of a mixed voice and an enhanced voice is advantageous as a voice to be used for voice recognition and an estimated or calculated set of an SNR and an SIR.

The identification model can also directly estimate which of a mixed voice and an enhanced voice is advantageous for voice recognition, using a feature amount acquired from the mixed voice as an input. In this case, the identification model is learned on the basis of pair data of a teacher label indicating which of a mixed voice and an enhanced voice is advantageous as a voice to be used for voice recognition and a feature amount extracted from the mixed voice.

In a case where the identification model uses both a mixed voice and a set of an SNR and an SIR as inputs, the identification model is learned on the basis of pair data of a teacher label indicating which of a mixed voice and an enhanced voice is advantageous as a voice to be used for voice recognition and the mixed voice and a set of an SNR and an SIR.

The identification model outputs a weight indicating how advantageous each of the mixed voice and the enhanced voice is as a voice to be used for voice recognition. Furthermore, the identification model may output a determination result in which one of the mixed voice and the enhanced voice is selected as a voice that is advantageous as a voice to be used for voice recognition.

The switching unit 1023 inputs the voice based on at least one of the mixed voice and the enhanced voice to the voice recognition unit 103 on the basis of the determination result of the determination unit 1022. In a case where the voice determination is performed hard as illustrated in FIG. 4, the switching unit 1023 inputs the enhanced voice or the mixed voice to the voice recognition unit 103 on the basis of the selection result of the determination unit 1022. In a case where the voice determination is performed softly (not illustrated), the switching unit 1023 weights the mixed voice and the enhanced voice according to the weight output from the determination unit 1022, and outputs the weighted mixed voice and enhanced voice to the voice recognition unit 103.

### [Processing Procedure of Signal Processing]

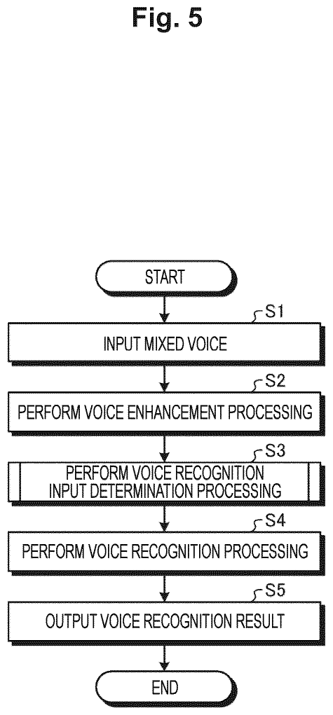

Next, signal processing executed by the signal processing device 100 will be described. FIG. 5 is a flowchart illustrating a processing procedure of signal processing according to the embodiment.

When receiving an input of a mixed voice (step S1), the voice enhancement unit 101 extracts a voice of a target speaker from the input mixed voice, and performs voice enhancement processing of inputting, to the voice recognition input determination unit 102, the extracted voice as an enhanced voice obtained by enhancing the mixed voice (step S2).

The voice recognition input determination unit 102 performs voice recognition input determination processing of determining a voice based on at least one of the mixed voice and the enhanced voice obtained by enhancing the mixed voice as a voice to be used for voice recognition, on the basis of at least one of the mixed voice and a set of an SNR of the mixed voice and an SIR of the mixed voice (step S3).

The voice recognition unit 103 performs voice recognition processing of performing voice recognition processing using the voice based on at least one of the mixed voice and the enhanced voice determined by the voice recognition input determination unit 102 (step S4), and outputs a voice recognition result (step S5).

### [Processing Procedure of Voice Recognition Input Determination Processing]

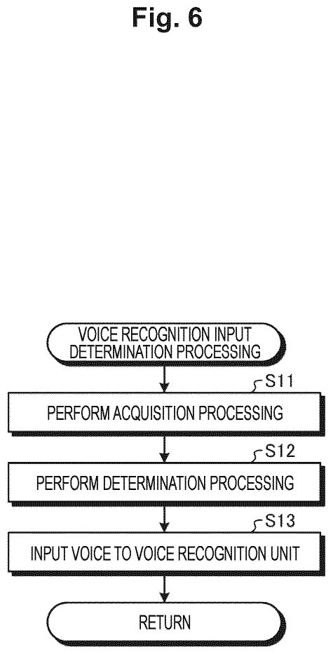

Next, the voice recognition input determination processing (step S3) in FIG. 5 will be described. FIG. 6 is a flowchart illustrating a processing procedure of the voice recognition input determination processing illustrated in FIG. 5.

As illustrated in FIG. 6, the SIR-SNR acquisition unit 1021 performs acquisition processing of acquiring at least one of the mixed voice and the set of the SIR of the mixed voice and the SNR of the mixed voice from the mixed voice input to the system (step S11).

On the basis of at least one of the mixed voice and the set of the SIR and the SNR acquired by the SIR-SNR acquisition unit 1021, the determination unit 1022 performs determination processing of determining the voice based on at least one of the mixed voice and the enhanced voice obtained by enhancing the mixed voice as a voice to be used for voice recognition (step S12). On the basis of the determination result of the determination unit 1022, the switching unit 1023 inputs, to the voice recognition unit 103, the voice based on at least one of the mixed voice and the enhanced voice as a voice to be used for voice recognition (step S13).

### Effects of Embodiment

As described above, on the basis of the fact that which of a mixed voice and an enhanced voice is advantageous as an input for voice recognition depends on an SIR and an SNR, the signal processing device 100 determines a voice based on at least one of the mixed voice and the enhanced voice as a voice to be used for voice recognition on the basis of at least one of the mixed voice and the set of the SIR and SNR.

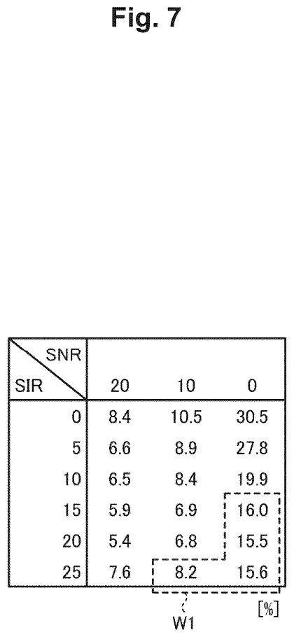

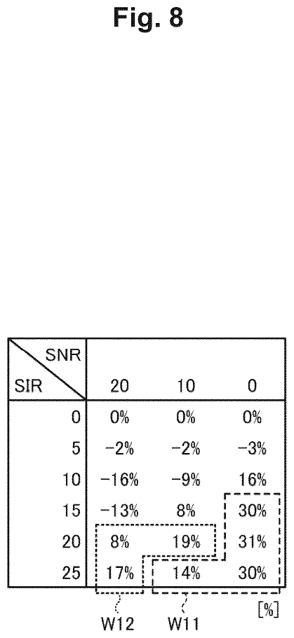

FIG. 7 is a diagram illustrating an example of voice recognition results in a case where the signal processing device 100 according to the embodiment is applied. FIG. 8 is a diagram illustrating an example of a performance improvement rate of the voice recognition results using the signal processing device 100 according to the embodiment with respect to voice recognition results in a case where the enhanced voice is used. FIGS. 7 and 8 illustrate the voice recognition results in a case where the voice to be input to the voice recognition unit 103 is selected by use of a rule of selecting the enhanced voice from among the enhanced voice and the mixed voice in the case of Expression (3). Note that, in both FIGS. 7 and 8, a character error rate was evaluated as voice recognition performance.

A region of a frame W1 illustrated in FIG. 7 and a region of a frame W11 illustrated in FIG. 8 are regions in which the mixed voice is considered to be selected as an input signal on the basis of an estimated set of an SIR and an SNR. From the voice recognition results of the frame W1 illustrated in FIG. 7 and the frame W11 illustrated in FIG. 8, it has been found that the signal processing device 100 that selects the signal to the voice recognition unit 103 using the rule of selecting the enhanced voice in the case of Expression (3) has higher voice recognition accuracy than in the case of using only the enhanced voice.

It has been found that, in the entire combinations of an SIR and an SNR, the signal processing device 100 has higher voice recognition accuracy on average than a case where only the enhanced voice is used. Furthermore, it has become clear that the signal processing device 100 has particularly higher voice recognition accuracy than in the case where only the enhanced voice is used in a region where the SIR value is relatively large (see, for example, the frames W11 and W12).

Therefore, according to the signal processing device 100, even in a case where a voice of another speaker overlaps with a voice of a target speaker, the voice based on at least one of the mixed voice and the enhanced voice obtained by enhancing the mixed voice is appropriately determined as an input voice capable of improving the accuracy of voice recognition. In addition, by appropriately determining the input voice capable of improving the accuracy of voice recognition, the signal processing device 100 can prevent performance deterioration due to distortion of voice enhancement and improve the voice recognition accuracy.

Note that, in the present embodiment, in a case where the mixed voice is selected as an input voice capable of improving the accuracy of voice recognition, the voice enhancement unit 101 does not have to perform the voice enhancement processing. As described above, the voice enhancement unit 101 performs the voice enhancement processing only for a section in which the voice enhancement processing is required, that is, only for a section in which the voice recognition input determination unit 102 selects the enhanced voice as an input voice capable of improving the accuracy of voice recognition.

### [System Configuration of Embodiment]

Each component of the signal processing device 100 is functionally conceptual, and does not necessarily have to be physically configured as illustrated. That is, specific forms of distribution and integration of the functions of the signal processing device 100 are not limited to the illustrated forms, and all or a part thereof can be functionally or physically distributed or integrated in any unit according to various loads, usage conditions, and the like.

Furthermore, all or any part of the processing performed in the signal processing device 100 may be implemented by a CPU, a graphics processing unit (GPU), and a program analyzed and executed by the CPU and the GPU. In addition, the processing performed in the signal processing device 100 may be implemented as hardware by wired logic.

Furthermore, among the processing described in the embodiment, all or a part of the processing described as being automatically performed can be manually performed. Alternatively, all or a part of the processing described as being manually performed can be automatically performed by a known method. In addition, the above-described and illustrated processing procedures, control procedures, specific names, and information including various data and parameters can be appropriately changed unless otherwise specified.

### [Program]

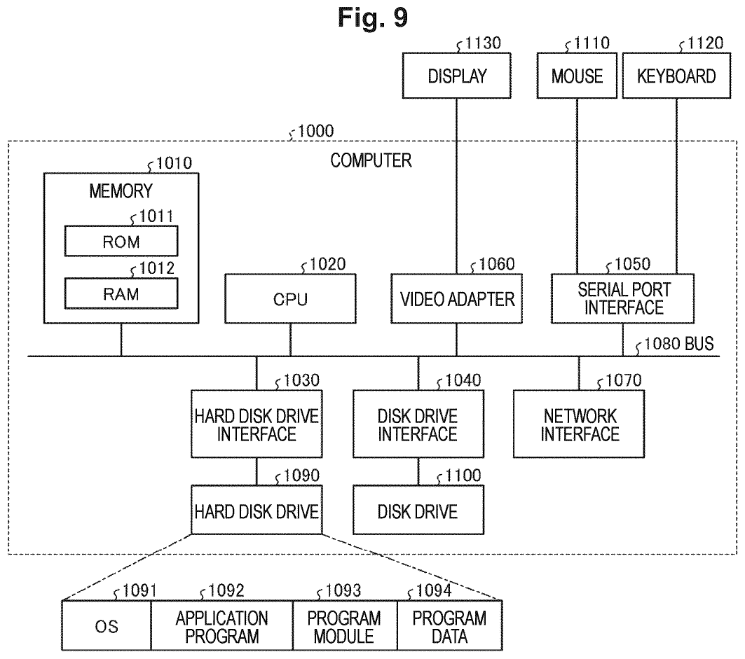

FIG. 9 is a diagram illustrating an example of a computer in which a program is executed and thus the signal processing device 100 is implemented. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, the program that defines the processing of the signal processing device 100 is implemented as the program module 1093 in which a code executable by the computer 1000 is described. The program module 1093 is stored in, for example, the hard disk drive 1090. For example, the program module 1093 for executing processing similar to the functional configuration in the signal processing device 100 is stored in the hard disk drive 1090. Note that the hard disk drive 1090 may be replaced with a solid state drive (SSD).

Furthermore, setting data used in the processing of the above-described embodiment is stored as the program data 1094, for example, in the memory 1010 or the hard disk drive 1090. In addition, the CPU 1020 reads the program module 1093 and the program data 1094 stored in the memory 1010 and the hard disk drive 1090 to the RAM 1012 as necessary and executes the program module 1093 and the program data 1094.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from another computer via the network interface 1070.

Although the embodiment to which the invention made by the present inventors is applied has been described above, the present invention is not limited by the description and drawings constituting a part of the disclosure of the present invention according to the present embodiment. That is, other embodiments, examples, operation techniques, and the like made by those skilled in the art and the like on the basis of the present embodiment are all included in the scope of the present invention.

### REFERENCE SIGNS LIST

100 Signal processing device
101 voice enhancement unit
102 voice recognition input determination unit
103 voice recognition unit
1021 SIR-SNR acquisition unit
1022 Determination unit
1023 Switching unit

1. A signal processing device, comprising:
acquisition circuitry that acquires, from a mixed voice in which a voice of another speaker overlaps with a voice of a target speaker, at least one of the mixed voice and a set of a signal-to-interference ratio (SIR) that is a ratio of a target voice to an interference speaker voice in the mixed voice and a signal-to-noise ratio (SNR) that is a ratio of the target voice to a noise in the mixed voice; and
determination circuitry that determines a voice based on at least one of the mixed voice and an enhanced voice obtained by enhancing the mixed voice as a voice to be used for voice recognition on a basis of at least one of the mixed voice and the set of the SIR and the SNR.

2. The signal processing device according to claim 1, wherein:
the determination circuitry determines the voice based on at least one of the mixed voice and the enhanced voice as the voice to be used for the voice recognition by use of a predetermined rule using the set of the SIR and the SNR.

3. The signal processing device according to claim 1, wherein:
the determination circuitry determines the voice based on at least one of the mixed voice and the enhanced voice as the voice to be used for the voice recognition by use of an identification model that has been learned with at least one of a feature amount acquired from the mixed voice and the set of the SNR and the SIR as an input, the feature amount and the set of the SNR and the SIR being each provided with a teacher label indicating which of the mixed voice and the enhanced voice is advantageous as the voice to be used for voice recognition.

4. The signal processing device according to claim 1, further comprising:
voice recognition circuitry that performs voice recognition processing using the voice based on at least one of the mixed voice and the enhanced voice determined by the determination circuitry.

5. The signal processing device according to claim 1, further comprising:
voice enhancement circuitry that extracts the voice of the target speaker from the mixed voice and inputs the extracted voice as the enhanced voice to the acquisition circuitry.

6. A signal processing method, comprising:
acquiring, from a mixed voice in which a voice of another speaker overlaps with a voice of a target speaker, at least one of the mixed voice and a set of a signal-to-interference ratio (SIR) that is a ratio of a target voice to an interference speaker voice in the mixed voice and a signal-to-noise ratio (SNR) that is a ratio of the target voice to a noise in the mixed voice; and
determining a voice based on at least one of the mixed voice and an enhanced voice obtained by enhancing the mixed voice as a voice to be used for voice recognition on a basis of at least one of the mixed voice and the set of the SIR and the SNR.

7. A non-transitory computer readable medium storing a signal processing program including computer readable instructions for causing a computer to execute:
acquiring, from a mixed voice in which a voice of another speaker overlaps with a voice of a target speaker, at least one of the mixed voice and a set of a signal-to-interference ratio (SIR) that is a ratio of a target voice to an interference speaker voice in the mixed voice and a signal-to-noise ratio (SNR) that is a ratio of the target voice to a noise in the mixed voice; and
determining a voice based on at least one of the mixed voice and an enhanced voice obtained by enhancing the mixed voice as a voice to be used for voice recognition on a basis of at least one of the mixed voice and the set of the SIR and the SNR.
